(19) United States
(12) Patent Application Publication
(10) Pub. No.: US 2009/0265736 A1
(43) Pub. Date: Oct. 22, 2009

(54) BROADCAST RECEIVING APPARATUS AND FIRMWARE UPGRADE METHOD THEREOF

(75) Inventor: Tae-yong SON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/237,526

(22) Filed: Sep. 25, 2008

(30) Foreign Application Priority Data
Apr. 22, 2008 (KR) 10-2008-0037236

(51) Int. Cl. H04N 5/445; H04N 7/173

(52) U.S. Cl. 725/37; 725/132; 717/173

(57) ABSTRACT

Provided are a broadcast receiving apparatus and a firmware upgrade method thereof The firmware upgrade method includes receiving firmware which is transmitted from headend equipment through an Ethernet and upgrading the firmware in the broadcast receiving apparatus. The determination whether to upgrade is based on product information transmitted from the headend equipment.

### CROSS-REFERENCE TO RELATED PATENT APPLICATION

This application claims priority of Korean Patent Application No. 10-2008-0037236, filed on Apr. 22, 2008, in the Korean Intellectual Property Office, the disclosure of which are incorporated herein in its entirety by reference.

### BACKGROUND OF THE INVENTION

1. Field of the Invention

Methods and apparatuses consistent with the present invention relate to a broadcast receiving apparatus and a firmware upgrade method of the broadcast receiving apparatus, and more especially to an Advanced Common Application Platform (ACAP) based broadcast receiving apparatus and a firmware upgrade method thereof

2. Description of the Related Art

The Advanced Common Application Platform (ACAP) is a standard for a middleware used in Digital Television (DTV) data broadcasting which is able to use both cable and terrestrial data broadcast contents. Examples of a broadcast receiving apparatus using the ACAP are a two-way Interactive TV and an Internet Protocol TV (IPTV) which support two-way data broadcasting.

When a user views the broadcast program using the two-way Interactive TV or the IPTV, the user may be provided with information related to the broadcast program or information not related to the broadcast program.

Firmware installed in the broadcast receiving apparatus such as the two-way Interactive TV or the IPTV may need an upgrade. Related art methods use a RS-232 cable or a USB memory for the firmware upgrade.

The related art method for the firmware upgrade needs a memory device which is able to be connected and disconnected and needs a preceding operation of storing the firmware in the memory device.

When using the RS-232 cable, a user needs to connect a notebook computer which has the firmware with the broadcast receiving apparatus through the RS-232 cable and to control the upgrade using the notebook computer. These two methods are inconvenient and inefficient in time and cost.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides firmware upgrade methods which receive a new version of the firmware through a return channel of the broadcast receiving apparatus and upgrade the firmware in the broadcast receiving apparatus and the broadcast receiving apparatuses thereof.

According to an aspect of the present invention, there is provided a method for upgrading a firmware in a broadcast receiving apparatus, the method comprising receiving a packet, extracting product information for the broadcast receiving apparatus from the received packet, comparing the product information extracted from the received packet with product information stored in the broadcast receiving apparatus, and upgrading the firmware in the broadcast receiving apparatus depending on the comparing.

The receiving of the packet may be receiving the packet from a transmission equipment of a broadcast station through a communication network.

The transmission equipment may be a headend equipment and the communication network may be Ethernet.

The product information for the broadcast receiving apparatus may be at least one of a model name, a manufacturer's name of the broadcast receiving apparatus, and a version of a firmware to be transmitted.

The upgrading the firmware in the broadcast receiving apparatus may include decompressing the packet if at least one of the model name and the manufacturer's name in the packet is a same with at least one of a model name and a manufacturer's name stored in the broadcast receiving apparatus.

The firmware upgrade method may further comprise generating a message for selecting whether to upgrade the firmware in the broadcast receiving apparatus if the version of the firmware to be transmitted is later version than a version of the firmware in the broadcast receiving apparatus.

The firmware upgrade method may further comprise noticing completion of the upgrade of the firmware in the broadcast receiving apparatus to the transmission equipment if the upgrade of the firmware in the broadcast receiving apparatus is completed.

The firmware upgrade method may further comprise controlling the message for selecting whether to upgrade the firmware in the broadcast receiving apparatus to be displayed on a screen as a pop-up window or to be output as a sound.

The firmware upgrade method may further comprise receiving a broadcast program transmitted through a broadcasting network, separating the received broadcast program into an audio signal and a video signal; generating a processed audio signal and a processed video signal by respectively processing the audio signal and the video signal, and outputting the processed audio signal and the processed video signal.

The product information for the broadcast receiving apparatus may be in a header of the packet and the firmware to be transmitted may be in a payload of the packet and in a compressed form.

The firmware to be transmitted may be transmitted in at least one packet.

The upgrading the firmware in the broadcast receiving apparatus may comprise sending a message for confirming the product information to the transmission equipment depending on the comparing and receiving a firmware transmitted from the transmission equipment and upgrading the firmware in the broadcast receiving apparatus with the firmware transmitted from the transmission equipment.

According to an aspect of the present invention, there is provided a broadcast receiving apparatus having a firmware therein, the apparatus comprising a transceiver unit which receives a packet and a control unit which extracts product information for the broadcast receiving apparatus from the packet received through the transceiver unit, performs a comparison of the product information extracted from the received packet with product information stored in the broadcast receiving apparatus, and upgrades the firmware in the broadcast receiving apparatus depending on the comparison.

The transceiver unit may receive the packet from transmission equipment of a broadcast station through a communication network.

The transmission equipment may be headend equipment and the communication network may be an Ethernet network.

The product information for the broadcast receiving apparatus may be at least one of a model name, a manufacturer's name of the broadcast receiving apparatus, and a version of a firmware to be transmitted.

The control unit may upgrade the firmware in the broadcast receiving apparatus by decompressing the packet if at least one of the model name and the manufacturer's name in the packet is a same as at least one of a model name and a manufacturer's name stored in the broadcast receiving apparatus.

The control unit may generate a message for selecting whether to upgrade the firmware in the broadcast receiving apparatus if the version of the firmware to be transmitted is later than a version of the firmware in the broadcast receiving apparatus.

The control unit may notice completion of the upgrade of the firmware in the broadcast receiving apparatus to the transmission equipment if the upgrade of the firmware in the broadcast receiving apparatus is completed.

The control unit may control the message for selecting whether to upgrade the firmware in the broadcast receiving apparatus to be displayed on a screen as a pop-up window or to be output as a sound.

The broadcast receiving apparatus may further comprise a tuner unit which receives a broadcast program transmitted through a broadcasting network, a signal processing unit which separates the received broadcast program to an audio signal and a video signal and processes the audio signal and the video signal, a video output unit which outputs the video signal processed by the signal processing unit, and an audio output unit which outputs the audio signal processed by the signal processing unit.

The product information for the broadcast receiving apparatus may be in a header of the packet and the firmware to be transmitted may be in a payload of the packet and in a compressed form.

The firmware to be transmitted may be transmitted in at least one packet.

The control unit may send a message for confirming the product information to the transmission equipment depending on the comparison and receive the firmware transmitted from the transmission equipment and upgrade the firmware in the broadcast receiving apparatus with the firmware transmitted from the transmission equipment.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a broadcast receiving apparatus according to an exemplary embodiment of the present invention;

FIG. 2 is a flow chart showing a firmware upgrade method of a broadcast receiving apparatus according to an exemplary embodiment of the present invention;

FIG. 3 is a diagram for explaining a method for providing firmware to a broadcast receiving apparatus according to an exemplary embodiment of the present invention;

FIG. 4 is a block diagram of the broadcast receiving apparatus of FIG. 4;

FIG. 5 is a flow chart of a firmware upgrade method of a broadcast receiving apparatus according to an exemplary embodiment of the present invention; and

FIG. 6 is a flow chart of a firmware upgrade method of a broadcast receiving apparatus according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are merely specific details provided to assist those of ordinary skill in the art in a comprehensive understanding of the invention, and the present invention is defined within the scope of the appended claims.

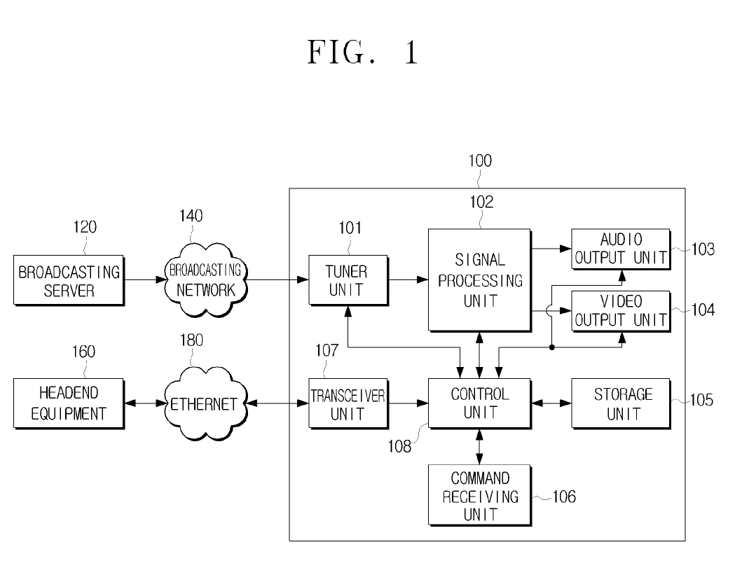

FIG. 1 is a block diagram of a broadcast receiving apparatus 100 according to an exemplary embodiment of the present invention.

Referring to FIG. 1, the broadcast receiving apparatus 100 includes a tuner unit 101, a signal processing unit 102, an audio output unit 103, a video output unit 104, a storage unit 105, a command receiving unit 106, a transceiver unit 107, and a control unit 108.

The tuner unit 101 tunes a broadcasting signal received from a broadcasting server 120 through a broadcasting network 140 such as a terrestrial network, a cable network, a satellite network, etc., demodulates the tuned broadcasting signal, corrects an error of the demodulated broadcasting signal, and outputs the error corrected broadcasting signal.

The signal processing unit 102 separates the output broadcasting signal to video data, audio data, and additional data, and decodes each data.

The video output unit 104 processes the video data decoded by the signal processing unit 102 to have a vertical frequency, a resolution, an aspect ratio, etc. of an output standard, and displays the processed video data.

The audio output unit 103 converts the audio data decoded by the signal processing unit 102 to an analog audio signal, amplifies the analog signal to a predetermined magnitude, and outputs the amplified audio signal.

The storage unit 105 stores various kinds of software programs which are required to perform operations of the broadcast receiving apparatus 100, and stores setting status of the broadcast receiving apparatus 100 set by a user. The storage unit 105 includes a Read Only Memory (ROM) where firmware for controlling operations of the broadcast receiving apparatus 100 is stored and a Random Access Memory (RAM) where data produced by operations of the broadcast receiving apparatus 100 is stored. The storage unit 105 may store product information of the broadcast receiving apparatus 100. The product information may include a model name and a manufacturer's name of the broadcast receiving apparatus 100, and version information of the firmware.

The command receiving unit 106 includes various keys for receiving a user's command, sends key signals corresponding to manipulation of the keys to the control unit 108, receives a user's command from a remote controller, and sends a signal corresponding to the user's command from the remote controller to the control unit 108.

The transceiver unit 107 performs as a return channel which transmits the user's command to headend equipment 160 through an Ethernet 180. The transceiver unit 107 receives packets comprising product information and firmware of the broadcast receiving apparatus 100 from the headend equipment 160 and sends the packets to the control unit 108. The transceiver unit 107 enables a user to use a two-way service.

The control unit 108 extracts the product information from the packets received through the transceiver unit 107, compares the product information in the packets with the stored product information in the storage unit 105, and upgrades the stored firmware to the firmware received from the transceiver unit 107 if the stored product information is the same as the product information in the packets. The product information the control unit 108 compares with the stored product information may be the model name or the manufacturer's name of the broadcast receiving apparatus 100.

In detail, if the packets comprising the product information and the firmware are received through the transceiver unit 107, the control unit 108 extracts the product information from the packets, and compares the product information in the packets with the stored product information in the storage unit 105. The product information of the broadcast receiving apparatus 100 is written in a header of the packets as a machine language which uses ‘0’ and ‘1’. The firmware to upgrade is written in a payload of the packets as a compressed form. Depending on size of the firmware, the firmware may be transmitted in one packet or a plurality of packets after the firmware is divided.

If the received product information is the same as the stored product information, the control unit 108 decompresses the compressed firmware in the payload and extracts the version information of the firmware. If the version of the firmware in the payload is the latest version, the control unit 108 generates a message for a user to choose to upgrade. The control unit 108 controls the video output unit 104 to display a pop-up message for choosing the firmware upgrade or the audio output unit 103 to output a sound message for choosing the firmware upgrade.

If a user chooses the firmware upgrade, the control unit 108 notices completion of the firmware upgrade to the headend equipment 160 after the completion of the firmware upgrade. The control unit 108 reboots the broadcast receiving apparatus 100 and causes the broadcast receiving apparatus 100 to operate by the upgraded firmware.

The version information of the firmware may be transmitted in the header of the packets. In this case, the control unit 108 compares the version information in the header with the stored version information in the storage unit 105. If the version in the header is not the latest version, the control unit 108 does not upgrade the firmware.

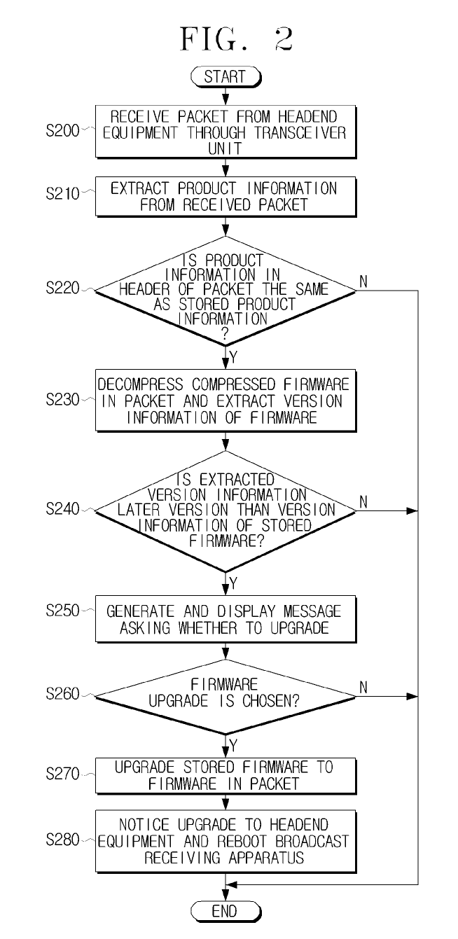

FIG. 2 is a flow chart showing a firmware upgrade method of the broadcast receiving apparatus according to an exemplary embodiment of the present invention.

Referring to FIG. 2, the broadcast receiving apparatus 100 receives a packet from the headend equipment 160 through the transceiver unit 107 (S200). The header of the packet output from the headend equipment 160 comprises the product information of the broadcast receiving apparatus 100. The payload of the packet comprises the firmware for the broadcast receiving apparatus 100. The transceiver unit 107 receives the packet output from the headend equipment 160 through the Ethernet 180.

The control unit 108 extracts the product information from the received packet (S210). The product information may comprise the model name or the manufacturer's name and may be written in a machine language in the header.

If the product information in the header of the packet is the same as the stored product information (S220-Y), the control unit 108 decompresses the compressed firmware in the packet and extracts the version information of the firmware (S230). If the product information in the header of the packet is not the same as the stored product information (S220-N), the broadcast receiving apparatus 100 does not upgrade the stored firmware.

If the extracted version of the firmware in the packet is a later version than the version of the stored firmware in the broadcast receiving apparatus 100 (S240-Y), the control unit 108 generates and displays a message asking whether to upgrade (S250). The control unit 108 may control the video output unit 104 to display a pop-up message asking whether to upgrade or control the audio output unit 103 to output a sound message whether to upgrade. If the extracted version of the firmware in the packet is not a later version than the version of the stored firmware in the broadcast receiving apparatus 100 (S240-N), the broadcast receiving apparatus 100 does not upgrade the stored firmware.

If a user chooses firmware upgrade referring to the message output from the broadcast receiving apparatus 100 (S260-Y), the control unit 108 upgrades the stored firmware to the firmware in the packet (S270), notices the upgrade to the headend equipment 160, and reboots the broadcast receiving apparatus 100 (S280).

If the version information is included in the extracted product information in operation S210, that is, the version information is included in the header of the packet with the model name or the manufacturer's name, the control unit 108 may not perform decompression of the firmware if the version of the firmware in the header is not a later version than the version of the stored firmware in the broadcast receiving apparatus 100.

By the aforementioned operations, it is possible to receive the firmware provided by the headend equipment 160 through the Ethernet 180 and to upgrade the firmware of the broadcast receiving apparatus 100.

The headend equipment 160 may send only product information including the version information and the model name or the manufacturer's name, when sending a first packet. If the model name or the manufacturer's name is the same as that of the broadcast receiving apparatus 100 and the version in the packet is a later version than the version in the broadcast receiving apparatus 100, the control unit 108 sends a confirmation message to the headend equipment 160. After receiving the confirmation message, the headend equipment 160 may send the compressed firmware. Because the product information is a small amount of data and the firmware is a large amount of data, transmitting time and network resources may be saved in case that the broadcast receiving apparatus 100 does not need to upgrade the firmware because the firmware version in the packet is not a later version.

FIG. 3 is a diagram for explaining a method for providing firmware to a broadcast receiving apparatus according to an exemplary embodiment of the present invention.

Referring to FIG. 3, a broadcast receiving apparatus 300 communicates with transmission equipment 350 of a broadcast station through a communication network 370, sends a user command input to the broadcast receiving apparatus 300 to the transmission equipment 350, and receives various additional data from the transmission equipment 350. The broadcast receiving apparatus 300 may receive the firmware provided by the transmission equipment 350 through the communication network 370 and upgrade firmware in the broadcast receiving apparatus 300. Headend equipment may be an example of the transmission equipment 350. An Ethernet or the internet may be an example of the communication network 370.

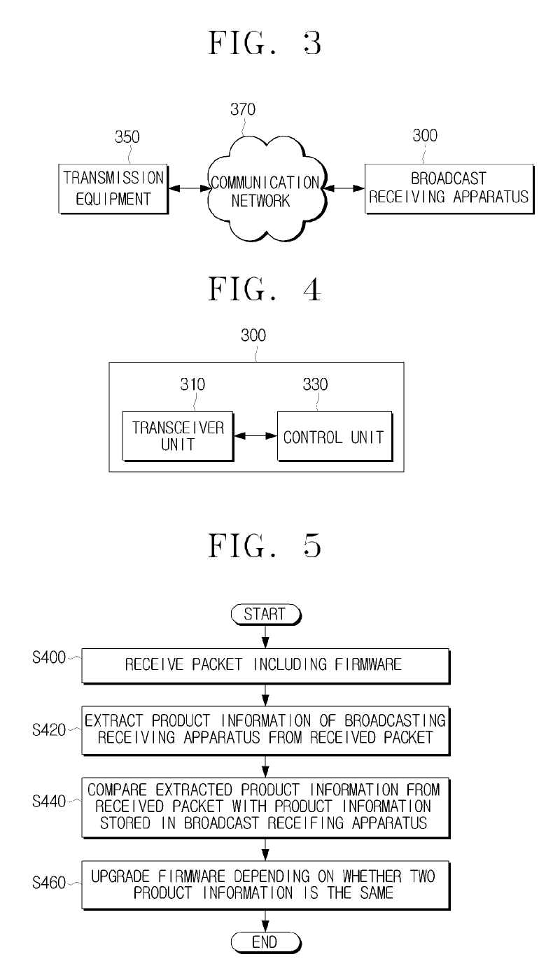

FIG. 4 is a block diagram of the broadcast receiving apparatus 300 of FIG. 3. The broadcast receiving apparatus 300 includes a transceiver unit 310 and a control unit 330.

The transceiver unit 310 performs as a return channel which sends a user command input to the broadcast receiving apparatus 300 to the transmission equipment 350 through the communication network 370 so that a user may use a two-way service. The transceiver unit 310 receives a packet including product information and firmware for the broadcast receiving apparatus 300 from the transmission equipment 350 and sends the packet to the control unit 330.

The control unit 330 extracts the product information from the packet received from the transceiver unit 310, compares the product information in the packet with the stored product information in the broadcast receiving apparatus 300 and upgrades the firmware in the broadcast receiving apparatus 300 according to a result of the comparison. That is, the model name, the manufacturer's name, and the firmware version information of the broadcast receiving apparatus 300 is stored already in the broadcast receiving apparatus 300 and the control unit 330 compares the stored product information with the product information received from the transmission equipment 350.

For example, if the product information is written in the packet header and the firmware is written in the packet payload transmitted from the transmission equipment 350, the control unit 330 extracts the model name or the manufacturer's name of the broadcast receiving apparatus from the packet header and compares the name with the model name or the manufacturer's name stored in the broadcast receiving apparatus 300. If the names match, the control unit 330 extracts the version information from the firmware in the packet payload and if the version of the firmware in the packet payload is a later version than the version of the firmware in the broadcast receiving apparatus 300, the control unit 330 upgrades the firmware in the broadcast receiving apparatus 300.

The product information of the broadcast receiving apparatus 300 is written in a machine language using ‘0’s and ‘1’s in the packet header. The firmware to be upgraded in the broadcast receiving apparatus 300 is written in compressed form in the packet payload. According to the size of the firmware to be upgraded, the firmware may be sent in one packet or in a plurality of packets which contain divided data of the firmware.

If the version information as the product information is transmitted with the model name and the manufacturer's name, the control unit 330 may check the version information in the packet header before decompressing the compressed firmware. If the version in the packet header is not a later version than the version of the firmware in the broadcast receiving apparatus 300, the control unit 330 does not need to decompress the compressed firmware.

For another example, the transmission equipment 350 may send only the product information including the model name or the manufacturer's name and the version information when the transmission equipment 350 sends the first packet. If the model name or the manufacturer's name matches that of the broadcast receiving apparatus 300 and the version in the packet is a later version than the version of the firmware, the control unit 330 sends a confirmation message to the transmission equipment 350. After receiving the confirmation message, the transmission equipment 350 may send the firmware in a compressed form. The control unit 330 may receive the firmware, decompress the firmware, and perform an upgrade.

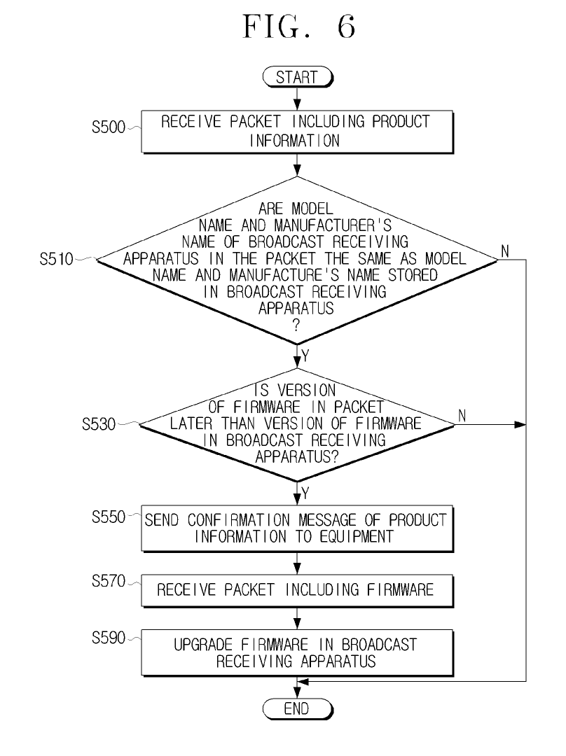

The aforementioned firmware upgrade method of the broadcast receiving apparatus 300 is explained using FIGS. 5 and 6.

FIG. 5 is a flow chart of a firmware upgrade method of a broadcast receiving apparatus according to an exemplary embodiment of the present invention.

Referring to FIG. 5, the control unit 330 receives a packet including the firmware through the transceiver unit 310 (S400). The product information is written in a machine language in the packet header transmitted from the transmission equipment 350 and the firmware is written in a compressed form in the packet payload.

The control unit 330 extracts the product information of the broadcast receiving apparatus 300 from the received packet (S420) and compares the extracted product information from the received packet with the product information stored in the broadcast receiving apparatus 300 (S440). The control unit 330 upgrades the firmware depending on whether the two product information is the same (S460).

In detail, the control unit 330 reads the model name or the manufacturer's name of the broadcast receiving apparatus 300, which is the product information written in the received packet header and compares the model name or the manufacturer's name with the model name or the manufacturer's name stored in the broadcast receiving apparatus 300. If the names match, the control unit 330 decompresses the compressed firmware in the packet payload and extracts the version information form the decompressed firmware. If the version in the packet is a later version than the version of the firmware in the broadcast receiving apparatus 300, the control unit 330 upgrades the stored firmware.

The version information of the firmware may be transmitted with the model name or the manufacturer's name of the broadcast receiving apparatus 300, included in the packet header. If the received version is not a later version than the version of the stored firmware, the process for decompression may be skipped.

FIG. 6 is a flow chart of a firmware upgrade method of a broadcast receiving apparatus according to another exemplary embodiment of the present invention.

The control unit 330 receives the packet including the product information from the transmission equipment 350 (S500). The model name and the manufacturer's name of the broadcast receiving apparatus 300 and the version information for the firmware to be transmitted is included in the product information.

The control unit 330 determines whether the model name and the manufacturer's name of the broadcast receiving apparatus 300 in the packet are the same as the model name and the manufacturer's name stored in the broadcast receiving apparatus 300 (S510). If the names are the same (S510-Y), the control unit 330 compares the version information of the firmware in the packet with the version information of the firmware stored in the broadcast receiving apparatus 300 (S530). If the version of the firmware in the packet is later than the version of the firmware in the broadcast receiving apparatus 300 (S530-Y), the control unit 330 sends a confirmation message of the product information to the transmission equipment 350 (S550).

The control unit 330 receives the packet including the firmware (S570) and upgrades the firmware in the broadcast receiving apparatus 300 (S590). The product information and the firmware is transmitted from the transmission equipment 350 to the broadcast receiving apparatus 300 through the communication network 370. The compressed firmware is transmitted in one packet or in a plurality of packets written in divided form.

By receiving the firmware to perform an upgrade from the headend equipment through the return channel of the broadcast receiving apparatus and upgrading the firmware in the broadcast receiving apparatus without using a RS-232 equipment or a USB memory, it is possible to save time and cost. The headend equipment may be, for example, a cable television headend.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for upgrading a firmware in a broadcast receiving apparatus, the method comprising:
receiving a packet;
extracting product information for the broadcast receiving apparatus from the received packet;
comparing the product information extracted from the received packet with product information stored in the broadcast receiving apparatus; and
upgrading the firmware in the broadcast receiving apparatus depending on the comparing.

2. The method of claim 1, wherein receiving the packet comprises receiving the packet from transmission equipment of a broadcast station through a communication network.

3. The method of claim 2, wherein the transmission equipment is headend equipment and the communication network is an Ethernet network.

4. The method of claim 1, wherein the product information for the broadcast receiving apparatus is at least one of a model name, a manufacturer's name of the broadcast receiving apparatus, and a version of a firmware to be transmitted.

5. The method of claim 4, wherein the upgrading the firmware in the broadcast receiving apparatus comprises decompressing the packet if at least one of the model name and the manufacturer's name in the packet is a same as at least one of a model name and a manufacturer's name stored in the broadcast receiving apparatus.

6. The method of claim 4, further comprising generating a message for selecting whether to upgrade the firmware in the broadcast receiving apparatus if the version of the firmware to be transmitted is later than a version of the firmware in the broadcast receiving apparatus.

7. The method of claim 2, further comprising noticing completion of the upgrade of the firmware in the broadcast receiving apparatus to the transmission equipment if the upgrade of the firmware in the broadcast receiving apparatus is completed.

8. The method of claim 6, further comprising controlling the message for selecting whether to upgrade the firmware in the broadcast receiving apparatus to be displayed on a screen as a pop-up window or to be output as a sound.

9. The method of claim 1, further comprising:
receiving a broadcast program transmitted through a broadcasting network;
separating the received broadcast program into an audio signal and a video signal;
generating a processed audio signal and a processed video signal by respectively processing the audio signal and the video signal; and
outputting the processed audio signal and the processed video signal.

10. The method of claim 1, wherein the product information for the broadcast receiving apparatus is in a header of the packet and the firmware to be transmitted is in a payload of the packet and in a compressed form.

11. The method of claim 4, wherein the firmware to be transmitted is transmitted in at least one packet.

12. The method of claim 2, wherein the upgrading the firmware in the broadcast receiving apparatus comprises:
sending a message for confirming the product information to the transmission equipment depending on the comparing; and
receiving a firmware transmitted from the transmission equipment and upgrading the firmware in the broadcast receiving apparatus with the firmware transmitted from the transmission equipment.

13. A broadcast receiving apparatus having a firmware therein, the apparatus comprising:
a transceiver unit which receives a packet; and
a control unit which extracts product information for the broadcast receiving apparatus from the packet received through the transceiver unit, performs a comparison of the product information extracted from the received packet with product information stored in the broadcast receiving apparatus, and upgrades the firmware in the broadcast receiving apparatus depending on the comparison.

14. The apparatus of claim 13, wherein the transceiver unit receives the packet from transmission equipment of a broadcast station through a communication network.

15. The apparatus of claim 14, wherein the transmission equipment is headend equipment and the communication network is an Ethernet network.

16. The apparatus of claim 14, wherein the product information for the broadcast receiving apparatus is at least one of a model name, a manufacturer's name of the broadcast receiving apparatus, and a version of a firmware to be transmitted.

17. The apparatus of claim 16, wherein the control unit upgrades the firmware in the broadcast receiving apparatus by decompressing the packet if at least one of the model name and the manufacturer's name in the packet is a same as at least one of a model name and a manufacturer's name stored in the broadcast receiving apparatus.

18. The apparatus of claim 16, wherein the control unit generates a message for selecting whether to upgrade the firmware in the broadcast receiving apparatus if the version of the firmware to be transmitted is later than a version of the firmware in the broadcast receiving apparatus.

19. The apparatus of claim 14, wherein the control unit notices completion of the upgrade of the firmware in the broadcast receiving apparatus to the transmission equipment if the upgrade of the firmware in the broadcast receiving apparatus is completed.

20. The apparatus of claim 18, wherein the control unit controls the message for selecting whether to upgrade the firmware in the broadcast receiving apparatus to be displayed on a screen as a pop-up window or to be output as a sound.

21. The apparatus of claim 13, further comprising:
a tuner unit which receives a broadcast program transmitted through a broadcasting network;
a signal processing unit which separates the received broadcast program into an audio signal and a video signal and processes the audio signal and the video signal;
a video output unit which outputs the video signal processed by the signal processing unit; and
an audio output unit which outputs the audio signal processed by the signal processing unit.

22. The apparatus of claim 13, wherein the product information for the broadcast receiving apparatus is in a header of the packet and the firmware to be transmitted is in a payload of the packet and in a compressed form.

23. The apparatus of claim 13, wherein the firmware to be transmitted is transmitted in at least one packet.

24. The apparatus of claim 14, wherein the control unit sends a message for confirming the product information to the transmission equipment depending on the comparison and receives the firmware transmitted from the transmission equipment and upgrades the firmware in the broadcast receiving apparatus with the firmware transmitted from the transmission equipment.
